(19) United States
(12) Patent Application Publication
(10) Pub. No.: US 2024/0005217 A1
(43) Pub. Date: Jan. 4, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Yuta HATAKEYAMA, Tokyo (JP); Yuzuru OKAJIMA, Tokyo (JP)

(73) Assignee: NEC Corporation, Minato-ku, Tokyo (JP)

(21) Appl. No.: 18/037,149

(22) PCT Filed: Nov. 30, 2020
(86) PCT No.: PCT/JP2020/044486

§ 371 Date: May 16, 2023

(51) Int. Cl. G06N 20/20

(52) U.S. Cl. CPC G06N 20/20

(57) ABSTRACT

An information processing device, an input means receives training examples formed by features. A label generation means assigns labels to the training examples using a teacher model. An error calculation means generates one or more student models using at least a part of the training examples to which the labels are assigned, and calculates errors between predictions of the one or more student models and predictions of the teacher model by using the error calculation examples different from examples used to generate the one or more student models. A data retention means retains examples formed by features. A data extraction means extracts and outputs each example for which the error is to be significant based on the errors calculated by the error calculation means, from the data retention means.

### TECHNICAL FIELD

The present disclosure relates to a technique for improving accuracy of a machine learning model.

### BACKGROUND ART

Active learning is known as a technique to improve accuracy of a machine learning model through supervised learning. The active learning is a technique to improve the accuracy of the machine learning model by re-training the machine learning model using examples which cannot be predicted well by a current machine learning model, to which a teacher (oracle) assigns labels and generates examples.

The active learning method basically considers “examples in which a student model outputs ambiguous predictions or contradictory predictions” as examples which cannot be predicted well, and re-trains the machine learning model by assigning labels to the examples. Uncertainty sampling and query-by-committee (QBC) are known as examples of the active learning. The uncertainty sampling is a method which assigns the labels to the examples which are close to decision boundary created by the student model, while the query-by-committee is a method which assigns the labels to the examples for which a plurality of student models output contradictory answers.

Non-Patent Document 1 also proposes a method which combines a GAN (Generative Adversarial Network) and the active learning. This method uses the GAN to create artificial examples in which a classifier to be a target outputs ambiguous predictions.

### PRECEDING TECHNICAL REFERENCES

### Patent Document

Non-Patent Document 1: Kong, Q., Tong, B., Klinkigt, M., Watanabe, Y., Akira, N., and Murakami, T, “Active generative adversarial network for image classification”, In Association for the Advancement of Artificial Intelligence, 2019, Airxiv: https://arxiv.org/abs/1906.07133

### SUMMARY

### Problem to be Solved by the Invention

However, a fact that a student model outputs an ambiguous prediction is not equal to a fact that the student model makes a wrong prediction. For example, the student model may make the wrong prediction even if an example is far from a decision boundary. Also, even if the student model predicts with a confidence level of almost “1”, the prediction may actually be wrong. This is especially true when the prediction of the student model is not reliable. Therefore, it is difficult in the above active learning method to efficiently find examples which significantly improve prediction accuracy.

It is one object of the present disclosure to efficiently find the examples which significantly improve the prediction accuracy.

### MEANS FOR SOLVING THE PROBLEM

According to an example aspect of the present disclosure, there is provided an information processing device including:
an input means configured to receive training examples formed by features;
a label generation means configured to assign labels to the training examples using a teacher model;
an error calculation means configured to generate one or more student models using at least a part of the training examples to which the labels are assigned, and calculate errors between predictions of the one or more student models and predictions of the teacher model by using error calculation examples different from the part of the training examples used to generate the one or more student models;
a data retention means configured to retain examples formed by features; and
a data extraction means configured to extract and output each example for which the error is to be significant based on the errors calculated by the error calculation means, from the data retention means.

According to another example aspect of the present disclosure, there is provided an information processing method including:
receiving training examples formed by features;
assigning labels to the training examples using a teacher model;
generating one or more student models using at least a part of the training examples to which the labels are assigned, and calculate errors between predictions of the one or more student models and predictions of the teacher model by using error calculation examples different from the part of the training examples used to generate the one or more student models; and
extracting and outputting each example for which the error is to be significant based on the calculated errors, from a data retention means which retains examples formed by features.

According to a further example aspect of the present disclosure, there is provided a recording medium storing a program, the program causing a computer to perform a process including:
receiving training examples formed by features;
assigning labels to the training examples using a teacher model;
generating one or more student models using at least a part of the training examples to which the labels are assigned, and calculate errors between predictions of the one or more student models and predictions of the teacher model by using error calculation examples different from the part of the training examples used to generate the one or more student models; and
extracting and outputting each example for which the error is to be significant based on the calculated errors, from a data retention means which retains examples formed by features.

### BRIEF DESCRIPTION OF THE DRAWINGS

FIG. 1 is a diagram conceptually illustrating a method of example embodiments.

FIG. 2 is a diagram conceptually illustrating an information processing device of the example embodiments.

FIG. 3 is a diagram illustrating a hardware configuration of the information processing device of a first example embodiment.

FIG. 4 is a diagram illustrating a functional configuration of the information processing device of the first example embodiment.

FIG. 5 is a diagram for explaining overfitting of prediction errors.

FIG. 6 illustrates a specific example for generating error calculation examples from training examples.

FIG. 7 is a flowchart of a process by the information processing device of the first example embodiment.

FIG. 8 is a diagram illustrating a functional configuration of an information processing device according to a second example embodiment.

FIG. 9 is a flowchart of a process of the information processing device according to the second example embodiment.

### EXAMPLE EMBODIMENTS

In the following, example embodiments will be described with reference to the accompanying drawings.

### First Example Embodiment

[Basic Principle]

In known active learning methods, labels are assigned and re-training is performed for examples for which a student model outputs an ambiguous prediction. However, as mentioned above, a fact that the student model outputs the ambiguous prediction is not equal to a fact that the student model makes a wrong prediction, and the prediction output by the student model with a confidence level “I” may be wrong. This is due to the fact that the examples used for re-training are selected based on the student model only. That is, since predictions of the student model are evaluated based on the confidence level and a probability output by the student model itself, pros and cons of the examples selected for re-training depend on an actual accuracy of the student model.

Therefore, in example embodiments, a teacher model which can be regarded as outputting absolutely correct predictions is prepared, and predictions of the student model are evaluated by comparing the predictions with those of the teacher model. By this comparison, in a case where the predictions of the student model are close to those of the teacher model, then the predictions of the student model are considered to be reliable. On the other hand, in a case where the predictions of the student model are far from the predictions of the teacher model, the predictions of the student model are considered suspect. Therefore, by selecting, as examples for re-training, examples in which each error between the prediction of the student model and the prediction of the teacher model is significant, it is possible to acquire examples which contribute significantly to improving accuracy.

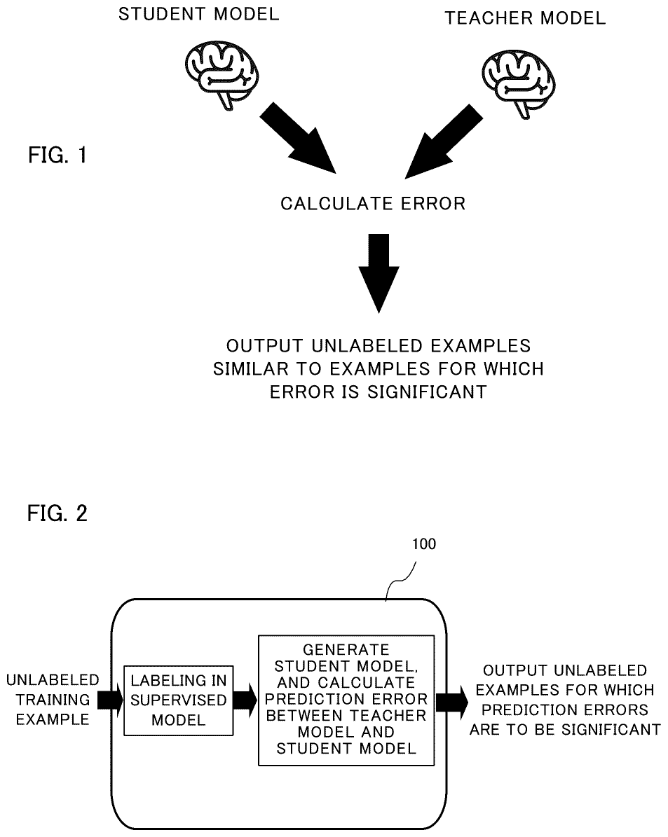

FIG. 1 conceptually illustrates a method in the present example embodiments. As described above, in addition to the student model to be trained, the teacher model is prepared, which can be regarded as outputting the absolutely correct predictions as described above. First, for a plurality of examples, predictions are made by the student model and the teacher model respectively, and errors in the predictions are calculated. Here, it is assumed that the examples used to calculate errors of the predictions correspond to examples (hereinafter, also referred to as “error calculation examples”) different from the examples used to train the student model (hereinafter, also referred to as “student model training examples”). After that, each example, for which the error calculated using the error calculation examples is significant, is selected, and an unlabeled example similar to that example is output. Accordingly, it is possible to output examples which contribute to improve the accuracy of the student model.

[Overall Configuration of an Information Processing Device]

FIG. 2 conceptually illustrates an information processing device in the present example embodiments. A plurality of unlabeled training examples are input to an information processing device 100. The information processing device 100 first assigns labels to the input unlabeled training examples with the teacher model described above. These labels correspond to the predictions made by the teacher model. Next, the information processing device 100 generates a student model using the labeled training examples.

Next, the information processing device 100 performs predictions of the error calculation examples by the generated student model and the teacher model, and calculates an error between the prediction of the student model and the prediction of the student model. After that, the information processing device 100 outputs each unlabeled example similar to the training example for which the calculated error is great. Each unlabeled example thus obtained corresponds to an example for which the error is predicted to be significant in a case where the prediction is carried out by the teacher model and the student model with respect to that example. Therefore, by labeling each of unlabeled examples and re-training the student model, it is possible to improve the accuracy of the student model.

[Hardware Configuration]

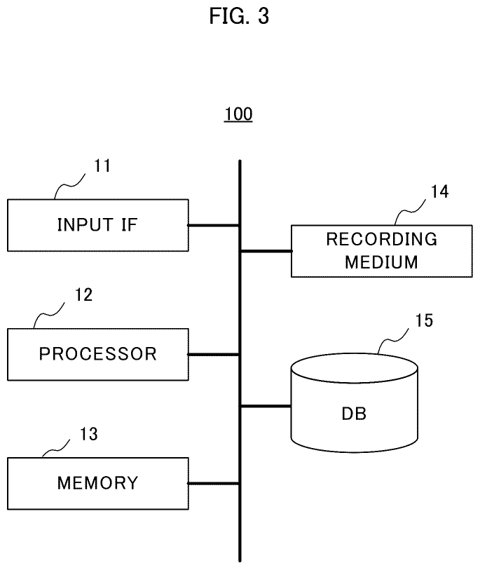

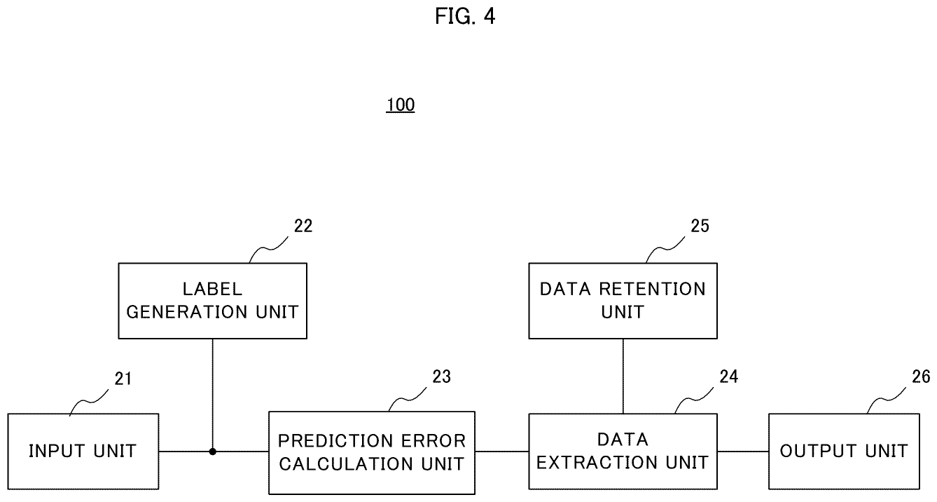

FIG. 3 is a block diagram illustrating a hardware configuration of the information processing device 100 of a first example embodiment. As illustrated in the figure, the information processing device 100 includes an input IF (InterFace) 11, a processor 12, a memory 13, a recording medium 14, and a database (DB) 15.

The input IF 11 inputs and outputs data. Specifically, the input IF 11 acquires training examples formed by features, and outputs each unlabeled example similar to an example having a significant error.

The processor 12 is a computer such as a central processing unit (CPU) or a graphics processing unit (GPU), and controls the entire information processing device 100 by executing a program prepared in advance. In particular, the processor 12 performs a process for outputting the unlabeled example similar to the example having the significant error.

The memory 13 consists of a ROM (Read Only Memory), a RAM (Random Access Memory), and the like. The memory 13 stores various programs executed by the processor 12. The memory 13 is also used as a working memory during executions of various processes by the processor 12.

The recording medium 14 is a non-volatile and non-transitory recording medium, such as a disk-shaped recording medium or semiconductor memory, and is removable from the information processing device 100. The recording medium 14 records various programs to be executed by the processor 12.

The DB 15 stores examples input from the input IF 11. In addition, each unlabeled example to be output from the information processing device 100 is stored in the DB 15.

[Functional Configuration]

FIG. 4 is a block diagram illustrating a functional configuration of the information processing device 100. The information processing device 100 includes an input unit 21, a label generation unit 22, a prediction error calculation unit 23, a data extraction unit 24, a data retention unit 25, and an output unit 26.

The unlabeled training examples which are used to train the student model and the trained teacher model are input to the input unit 21. The training example is formed by multi-dimensional features. The input unit 21 outputs the unlabeled training examples and the trained teacher model to the label generation unit 22. The input unit 21 also outputs the unlabeled training examples to the prediction error calculation unit 23.

The label generation unit 22 generates labels for the input unlabeled training examples using the trained teacher model, and outputs the labels to the prediction error calculation unit 23. Note that these labels correspond to respective predictions of the teacher model for the input unlabeled training examples.

The prediction error calculation unit 23 acquires the unlabeled training examples from the input unit 21, and also acquires the labels assigned respectively to the training examples from the label generation unit 22. As a result, the labeled training examples are provided to the prediction error calculation unit 23. The prediction error calculation unit 23 trains the student model using these labeled training examples, and generates the trained student model.

Next, the prediction error calculation unit 23 performs the prediction using the generated student model. The prediction error calculation unit 23 calculates the error between the prediction by the student model and the label input from the label generation unit 22, that is, the error between the prediction by the student model and the prediction by the teacher model, and outputs the error to the data extraction unit 24. In the calculation of the prediction error, the error calculation examples are used, which are different examples from the training example used for training the student model. The calculated prediction errors are output to the data extraction unit 24.

Here, the reason why the prediction error calculation unit 23 calculates the prediction errors using examples different from the training examples used for training the student model will be described. In the information processing device 100 described above, the teacher model is used to assign the labels to the unlabeled training examples input from the input unit 21 to generate the labeled training examples, and the student model is trained using the labeled training examples. Therefore, in a case where the prediction error calculation unit 23 calculates the prediction errors between the teacher model and the student model using the same training example as the training examples used for training the student model, since the prediction of the teacher model matches the prediction of the student model for each of the training examples, the calculated prediction errors become zero at all points corresponding to the training examples. In other words, overfitting occurs in the prediction itself of the error, and an error smaller than an original error is predicted. This is called “overfitting of the prediction error”.

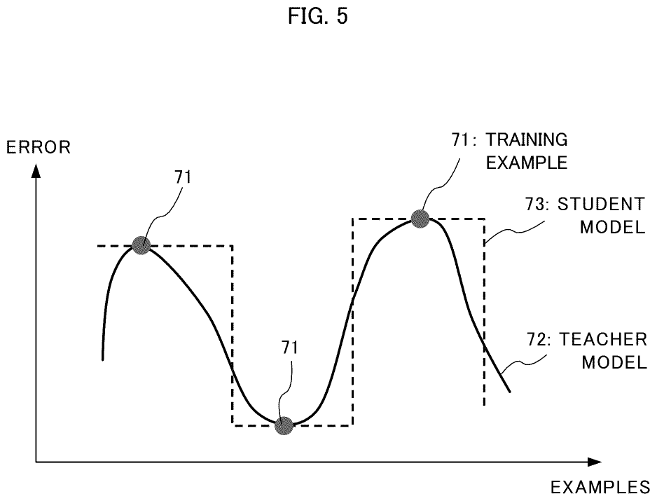

FIG. 5 illustrates the overfitting of the prediction errors. In FIG. 5, it is assumed that a plurality of points 71 represent the training examples and a graph 72 with a solid line represents the teacher model. Since the student model is trained using the labels assigned by the teacher model to the training examples as teacher data, the student model is trained so that the prediction errors with respect to the teacher model is zero at locations of training examples 71, as depicted in a graph 73 with a dashed line. Therefore, when the prediction errors between the teacher model and the student model are calculated using the same training examples as the training examples used for training the student model, the prediction errors between the teacher model and the student model are not correctly estimated.

Therefore, in the present example embodiments, the prediction errors between the teacher model and the student model are calculated using the error calculation examples which are different examples from the training examples used for training the student model. In the following, a method for preparing the error calculation examples will be described below.

(Method 1) Generate Error Calculation Examples by Oversampling

Oversampling is a method for artificially generating examples, that is, SMOTE, MUNGE, or the like. Specifically, all previously prepared training examples are used as the student model training examples to train the student model. New unlabeled examples x′ are created from the training examples by oversampling, and are used as examples for an error calculation. After that, using new unlabeled examples x′, each prediction error between the teacher model and the student model is calculated, for instance, by the following expression.

Prediction error=|Teacher·predict(x′)−Student·predict(x′)| (1)

Note that it is assumed that the error is calculated by this equation (1) the above, but this norm needs not be an Euclidean norm, and an any norm can be used. Moreover, the prediction error calculation unit 23 may convert outputs of the predictions by the teacher and student models into respective probability distributions, and then may calculate the error by taking the Kullback-Leibler divergence of the two outputs.

(Method 2) Generate Examples for the Error Calculation by Dividing the Training Examples.

In a method 2, the training examples labeled by the teacher model are divided, and some of the divided training examples are used as the training examples for the student model to train the student model. Moreover, the remaining training examples are used as the error calculation examples to calculate respective prediction errors of the teacher model and the student model.

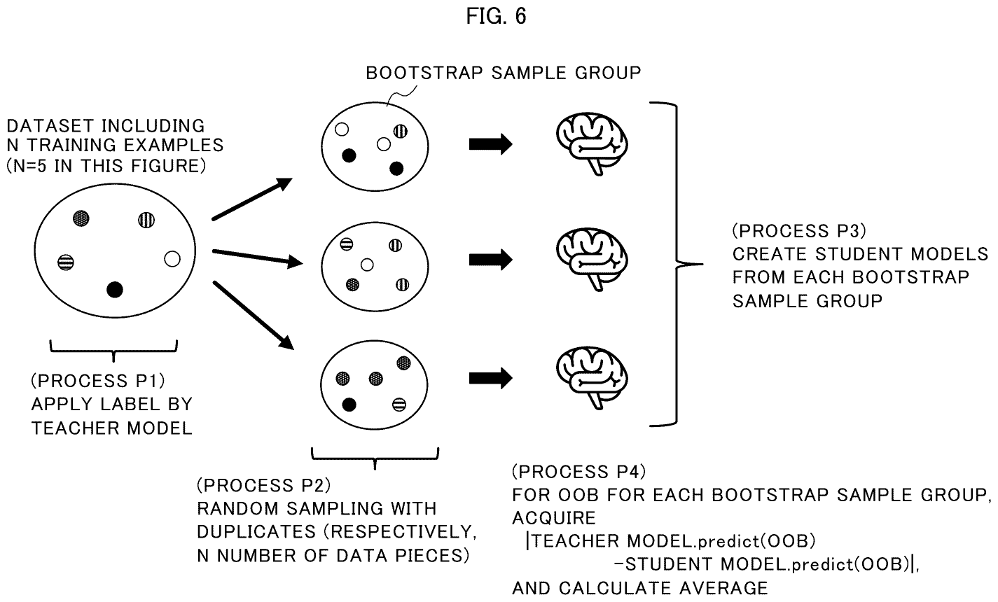

FIG. 6 illustrates a specific example for generating examples for the error calculation by dividing the training examples according to the method 2. As illustrated in the figure, it assumed that a data set including N training examples (N=5 in the example in FIG. 6) is input from the input unit 21. First, the label generation unit 22 assigns labels to all data of the training examples using the teacher model (process P1).

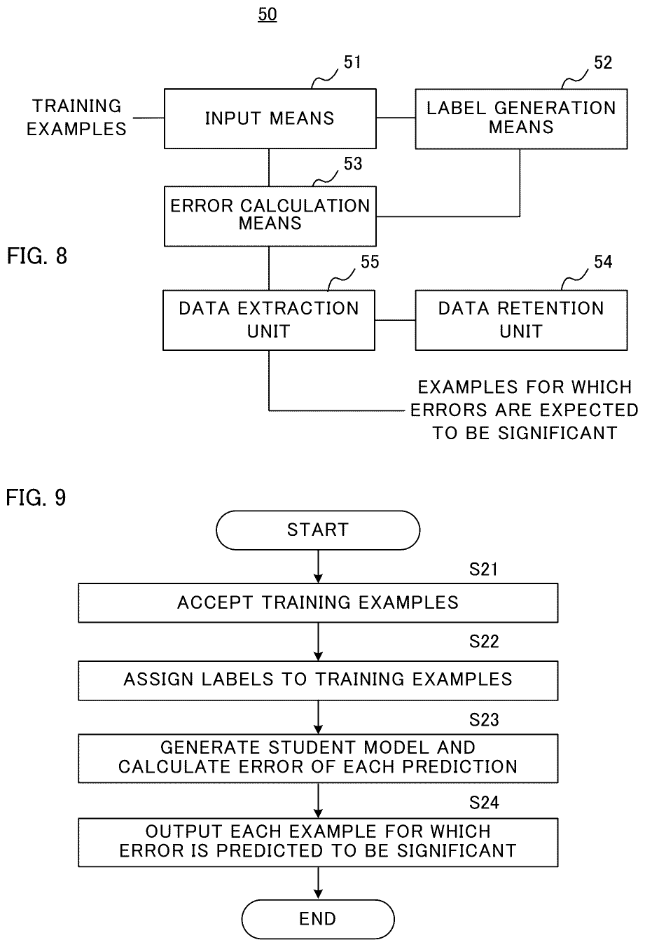

Next, the prediction error calculation unit 23 performs random sampling with duplicates (bootstrap sampling) from the training examples to generate M bootstrap sample groups (M=3 in the example in FIG. 8) (process P2). The number of data pieces in each of the bootstrap sample groups is N. After that, the prediction error calculation unit 23 creates the student model using each of the bootstrap sample groups (process P3). By these processes, M student models are generated.

Since each of the bootstrap sample groups is generated by the random sampling with duplicates from the training examples, there are samples which are included in the training examples but not selected for the bootstrap sample groups. These are called Out-Of-Bag (OOB) samples. The OOB samples are not used to generate the student model because these samples are not included in the bootstrap sample groups. Therefore, the prediction error calculation unit 23 uses the OOB samples of each of the bootstrap sample groups as examples for the error calculation, and calculates the prediction error between the teacher model and the student model for each of the OOB samples.

In detail, regarding the OOB examples for each of bootstrap sample groups, the prediction error calculation unit 23 acquires predictions made by the student model corresponding to that bootstrap sample group and the teacher model. After that, the prediction error calculation unit 23 calculates the prediction errors for each of the M bootstrap sample groups using the following expression, and outputs the average of the prediction errors to the data extraction unit 24 as the prediction error (process P4).

Prediction error=|Teacher·predict(OOB)−Student·predict(OOB)| (2)

In this way, the prediction errors between the teacher model and the student model can be calculated using the examples which differ from the training examples used to generate the student model.

(Method 3) Acquire Other Training Examples

In a method 3, all training examples input in the input unit 21 are used as the student model training examples to generate the student model. On the other hand, unlabeled examples which differ from the training examples are separately acquired and used as examples for the error calculation. In a case where the unlabeled examples exist in advance, the unlabeled examples may be used. This method does not require duplicate sampling as described above for the unlabeled examples.

As described above, by calculating the prediction errors between the teacher model and the student model by using error calculation examples which are different from the training examples used for training the student model, the prediction error calculation unit 23 can suppress an occurrence of overfitting of the prediction error and accurately calculate each prediction error.

Returning to FIG. 4, the data retention unit 25 stores a plurality of unlabeled examples in advance. The unlabeled examples stored in the data retention unit 25 may include one or more examples artificially generated from the training examples by an oversampling method (such as the SMOTE).

The data extraction unit 24 extracts the unlabeled examples similar to examples which are input from the prediction error calculation unit 23 from the data retention unit 25 and for which the errors are significant. Specifically, first, the data extraction unit 24 selects each example where the error is significant based on the errors output from the prediction error calculation unit 23. Note that the data extraction unit 24 may select, for instance, a predetermined number of examples in an order of greater errors or examples for which the errors are greater than a predetermined threshold value, as “examples for which the errors are significant” as described above.

Here, the data extraction unit 24 may consider a distribution (degree of appearance) of the examples instead of simply selecting the examples having a significant error. Specifically, the data extraction unit 24 may estimate a density of the examples by a density estimation or the like, and may select the examples in which a weighted sum of the distribution and the error increases as “the examples in which the errors are significant”. For instance, the data extraction unit 24 first estimates the distribution (degree of appearance) p(x₁), . . . . , p(xₙ) with respect to the examples x₁, . . . xₙ. Next, the data extraction unit 24 uses an error eᵢ of the example xᵢ and a fixed hyper parameter α, β(0≤α, β≤1), calculates the following error:

eᵢ^{new}(xᵢ)=ap(xᵢ)+βeᵢ [Math 1]

and outputs the example xᵢ for which the error eᵢ^{new}(xᵢ) is significant.

Accordingly, after selecting the examples having the significant error, the data extraction unit 24 acquires each unlabeled example similar to the selected example from the data retention unit 25. Specifically, the data extraction unit 24 acquires each unlabeled example having a close distance to the selected example from the data retention unit 25 by using a method for measuring each distance among the examples such as a cosine similarity degree or a k-neighborhood method. The data extraction unit 24 outputs each of the unlabeled examples being acquired to the output unit 26.

The data extraction unit 24 may consider degrees of similarity between each of the examples and respective unlabeled examples stored in the data retention unit 25. For instance, the data extraction unit 24 may measure the degrees of similarity between each of the examples and respective unlabeled examples, add the degree of similarity as the weight to the error for each of the examples, and output the unlabeled example having the greatest sum to the output unit 26.

Specifically, the data extraction unit 24 calculates each of degrees of similarity between the examples x₁, . . . xₙ and the unlabeled example z, by using a cosine similarity:

sᵢ(z)=similarity(z,xᵢ) [Math 2]

Next, the data extraction unit 24 regards the error of the example xᵢ as eᵢ, and calculates the following weighted sum for all unlabeled examples z:

Σᵢ₌₁ⁿsᵢ(z)eᵢ [Math 3]

Subsequently, the data extraction unit 24 outputs the unlabeled examples z having the greatest weighted sum.

The output unit 26 outputs each of the examples input from the data extraction unit 24 as an “example for which the error is predicted to be significant”. The examples output in this way are used to re-train the student model. Specifically, the teacher model used in the label generation unit 22 may be used to assign the labels to the examples being output, and the examples may be used as the training examples to re-train the student model. Alternatively, the examples being output may be labeled by a teacher model different from the teacher model used in the label generation unit 22 or by hand.

[Process by the Information Processing Device]

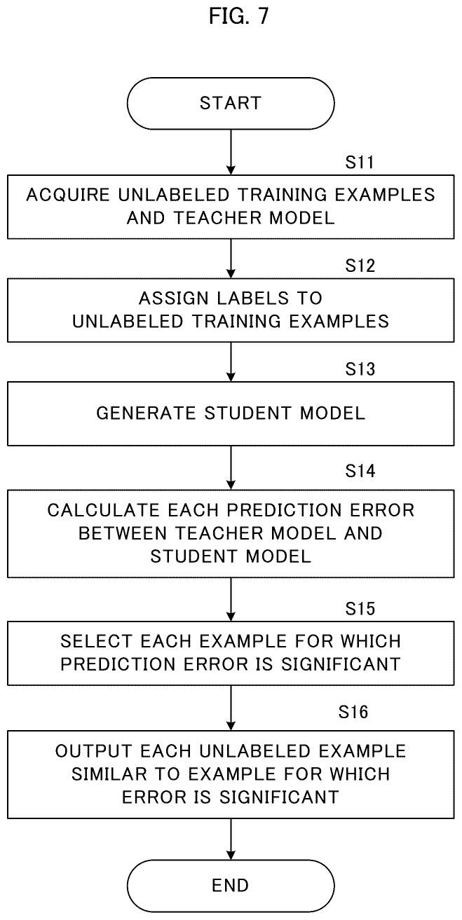

Next, a process for outputting each example for which the error is predicted to be significant by the information processing device 100 will be described. FIG. 7 is a flowchart of the process for outputting the example. This process is realized by the processor 12 depicted in FIG. 3 which executes a program prepared in advance and operates as each of elements depicted in FIG. 4.

First, the input unit 21 acquires the unlabeled training examples and the teacher model (step S11). Next, the label generation unit 22 assigns the labels to the unlabeled training examples using the teacher model (step S12). Subsequently, the prediction error calculation unit 23 generates the student model using the training examples labeled in step S12 (step S13).

Next, the prediction error calculation unit 23 calculates respective prediction errors between the teacher model and the student model for the error calculation examples (step S14). Subsequently, the data extraction unit 24 selects each example for which the error is significant (step S15), acquires one or more unlabeled examples similar to that example from the data retention unit 25, and the one or more unlabeled examples are output from the output unit 26 (step S16). After that, the process is terminated.

[Modifications]

Next, modifications of the first example embodiment will be described. The following modifications can be applied to the first example embodiment in appropriate combination.

(Modification 1)

In the above-described example embodiment, the label generation unit 22 assigns the labels to the unlabeled training examples input to the input unit 21 using the trained teacher model prepared in advance. Alternatively, in a case of inputting the labeled training examples to the input unit 21, the label generation unit 22 may first generate the teacher model using the labeled training examples. In the label generation unit 22, instead of assigning the labels using the teacher model, the labels may be assigned by hand. In the above-described example embodiment, although the prediction error calculation unit 23 generates the student model by using the training examples in which the label generation unit 22 assigns the labels, instead, the prediction error calculation unit 23 may acquire the trained student model prepared in advance.

(Modification 2)

In the above-described example embodiment, the output unit 26 outputs each unlabeled example similar to the example for which the error is significant, but a labeling unit may be provided at a subsequent stage of the output unit 26. In this manner, the unlabeled examples output by the output 26 may be labeled by the labeling unit, and it is possible to generate labeled training examples which can be used to re-train the student model. Note that in this case, the labeling unit may assign labels using the teacher model used by the label generation unit 22, may assign the labels using a teacher model different from the teacher model used by the label generation unit 22, or may assign the labels by hand or the like.

### Second Example Embodiment

FIG. 8 is a block diagram illustrating a functional configuration of an information processing device 50 according to a second example embodiment. The information processing device 50 includes an input means 51, a label generation means 52, an error calculation means 53, a data retention means 54, and a data extracting means 55. The input means 51 receives each training example formed by features. The label generation means 52 assigns labels to the training examples using the teacher model. The error calculation means 53 generates one or more student models using at least a part of the training examples to which the labels are assigned, and calculates the error between the prediction by the student model and the prediction by the teacher model using each error calculation example different from the examples used to generate the one or more student models. The data retention means 54 retains the examples formed by features. Based on the errors calculated by the error calculation means 53, the data extraction means 55 extracts and outputs each example for which the error is predicted to be significant from the data retention means 54.

FIG. 9 is a flowchart illustrating a process performed by the information processing device 50 according to the second example embodiment. The input means 51 receives training examples formed by the features (step S21). The label generation means 52 assigns labels to the training examples using the teacher model (step S22). The error calculation means 53 generates one or more student models using at least a part of the labeled training examples, and calculates errors between predictions by the student models and predictions by the teacher models using the error calculation examples which differ from those used for generating the one or more student models (step S23). Based on the errors calculated by the error calculation means 53, the data extraction means 55 extracts and outputs examples for which the errors are predicted to be significant from the data retention means 54 (step S24).

According to the information processing device 50 of the second example embodiment, examples, for which errors of the prediction between the teacher model and the student model are predicted to be significant, are output. Therefore, by re-training the student model using the output examples, it is possible to efficiently improve the accuracy of the student model.

A part or all of the example embodiments described above may also be described as the following supplementary notes, but not limited thereto.

(Supplementary Note 1)

An information processing device comprising:
an input means configured to receive training examples formed by features;
a label generation means configured to assign labels to the training examples using a teacher model;
an error calculation means configured to generate one or more student models using at least a part of the training examples to which the labels are assigned, and calculate errors between predictions of the one or more student models and predictions of the teacher model by using error calculation examples different from the part of the training examples used to generate the one or more student models;
a data retention means configured to retain examples formed by features; and
a data extraction means configured to extract and output each example for which the error is to be significant based on the errors calculated by the error calculation means, from the data retention means.

(Supplementary Note 2)

The information processing device according to supplementary note 1, wherein the data extraction means selects each example for which the error calculated by the error calculation means is significant, extracts each example similar to the selected example from the data retention means, and outputs the extracted example as an example for which the error is predicted to be significant.

(Supplementary Note 3)

The information processing device according to supplementary note 2, wherein the data extraction means calculates a degree of appearance, and determines each error calculation example for which a weighted sum of the degree of appearance and the error as an example for which the error is significant.

(Supplementary Note 4)

The information processing device according to any one of supplementary notes 1 to 3, wherein the error calculation means generates new error calculation examples by oversampling from the training examples.

(Supplementary Note 5)

The information processing device according to any one of supplementary notes 1 to 3, wherein the error calculation means generates the one or more student models, and calculates the errors using a remaining part of the training examples as the error calculation examples.

(Supplementary Note 6)

The information processing device according to any one of supplementary notes 1 to 3, wherein the error calculation means generates a plurality of sample groups by random sampling with duplicates from the training examples, generates the one or more student models using respective sampling groups, calculates the errors using, as the error calculation examples, samples included in the training examples but not included in the sample groups for each of the one or more student models, and calculates an average of the errors calculated for the one or more students as the errors with respect to the predictions of the one or more students and the predictions of the teacher model.

(Supplementary Note 7)

The information processing device according to any one of supplementary notes 1 to 3, wherein the error calculation means calculates the errors using examples other than the training example as the error calculation examples.

(Supplementary Note 8)

An information processing method comprising:
receiving training examples formed by features;
assigning labels to the training examples using a teacher model;
generating one or more student models using at least a part of the training examples to which the labels are assigned, and calculate errors between predictions of the one or more student models and predictions of the teacher model by using error calculation examples different from the part of the training examples used to generate the one or more student models; and
extracting and outputting each example for which the error is to be significant based on the calculated errors, from the data retention means which retains examples formed by features.

(Supplementary Note 9)

A recording medium storing a program, the program causing a computer to perform a process comprising:
receiving training examples formed by features;
assigning labels to the training examples using a teacher model;
generating one or more student models using at least a part of the training examples to which the labels are assigned, and calculate errors between predictions of the one or more student models and predictions of the teacher model by using error calculation examples different from the part of the training examples used to generate the one or more student models; and
extracting and outputting each example for which the error is to be significant based on the calculated errors, from the data retention means which retains examples formed by features.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

11 Input IF
12 Processor
13 Memory
14 Recording medium
15 Database
21 Input unit
22 Label generation unit
23 Prediction error calculation unit
24 Data extraction unit
25 Data retention unit
26 Output unit
100 Information processing device

What is claimed is:

1. An information processing device comprising:
a memory storing instructions; and
one or more processors configured to execute the instructions to:
receive training examples formed by features;
assign labels to the training examples using a teacher model;
generate one or more student models using at least a part of the training examples to which the labels are assigned, and calculate errors between predictions of the one or more student models and predictions of the teacher model by using error calculation examples different from the part of the training examples used to generate the one or more student models;
retain examples formed by features in a data retention means; and
extract and output each example for which the error is to be significant based on the calculated errors, from the data retention means.

2. The information processing device according to claim 1, wherein the processor selects each example for which the calculated error is significant, extracts each example similar to the selected example from the data retention means, and outputs the extracted example as an example for which the error is predicted to be significant.

3. The information processing device according to claim 2, wherein the processor calculates a degree of appearance, and determines each error calculation example for which a weighted sum of the degree of appearance and the error as an example for which the error is significant.

4. The information processing device according to claim 1, wherein the processor generates new error calculation examples by oversampling from the training examples.

5. The information processing device according to claim 1, wherein the processor generates the one or more student models, and calculates the errors using a remaining part of the training examples as the error calculation examples.

6. The information processing device according to claim 1, wherein the processor generates a plurality of sample groups by random sampling with duplicates from the training examples, generates the one or more student models using respective sampling groups, calculates the errors using, as the error calculation examples, samples included in the training examples but not included in the sample groups for each of the one or more student models, and calculates an average of the errors calculated for the one or more students as the errors with respect to the predictions of the one or more students and the predictions of the teacher model.

7. The information processing device according to claim 1, wherein the processor calculates the errors using examples other than the training example as the error calculation examples.

8. An information processing method comprising:
receiving training examples formed by features;
assigning labels to the training examples using a teacher model;
generating one or more student models using at least a part of the training examples to which the labels are assigned, and calculate errors between predictions of the one or more student models and predictions of the teacher model by using error calculation examples different from the part of the training examples used to generate the one or more student models; and
extracting and outputting each example for which the error is to be significant based on the calculated errors, from a data retention means which retains examples formed by features.

9. A non-transitory computer-readable recording medium storing a program, the program causing a computer to perform a process comprising:
receiving training examples formed by features;
assigning labels to the training examples using a teacher model;
generating one or more student models using at least a part of the training examples to which the labels are assigned, and calculate errors between predictions of the one or more student models and predictions of the teacher model by using error calculation examples different from the part of the training examples used to generate the one or more student models; and
extracting and outputting each example for which the error is to be significant based on the calculated errors, from a data retention means which retains examples formed by features.
